(19) United States
(12) Patent Application Publication
(10) Pub. No.: US 2012/0231799 A1
(43) Pub. Date: Sep. 13, 2012

(54) Telephone System and Method

(76) Inventor: Husain K. Alotaibi, Rabiya (KW)

(21) Appl. No.: 13/044,710

(22) Filed: Mar. 10, 2011

(51) Int. Cl. H04W 40/02

(52) U.S. Cl. 455/445

(57) ABSTRACT

A telephone system and method for reducing the costs for out of area calls made on a cell phone. The system includes a cell phone, a local telephone number, a land line and an access code and a timer. The system records the telephone number of the cell phone that dials into the system and immediately disconnects the call. The system recalls the cell phone with a message to enter a requested out of area phone number, completes the call over a land line and connects the requested number to the cell phone as an incoming or local call. The cell phone user is then billed for the use of the land line.

### FIELD OF THE INVENTION

This invention relates to a telephone system and method and more particularly to a telephone system and method for receiving a telephone call from a cell phone, recording an out of area telephone number from the cell phone, making a telephone call to the recorded number over a land line and connecting a completed call to the cell phone user as a local or incoming call plus forwarding a bill for use of the land line to the cell phone user.

### BACKGROUND FOR THE INVENTION

The use of cell phones has been expanding at an exponential rate and has grown to the extent that more and more business men and even school children carry a cell phone and use them extensively. However, it is also true that in some businesses the cost of cell phone usage is a growing concern and efforts are being made to reduce such costs.

The existence of “charge lines” and “non-charge lines” is well known and has been addressed in a U.S. Pat. No. 5,299,258 of Tsumura et al. As disclosed therein, an information input/output controller for telephone lines converts information input from either a charge line or a non-charge line to data form and then stores it in a memory device along with identification data specifying the type of line on which the information was received. It also reads information from the memory device in response to information read requests received by way either of a charge line or of a non-charge line, and when called upon to output the information either to a charge line or to a non-line it inhibits the output of the information to a non-charge line in cases where the line indicated by the aforementioned identification data on the line and the line on which the information read request if received are both non-charge lines. This enables either the sending party or the receiving party of a service, but not both, to be charged for the service while at the same time ensuring that, if the sending party and the receiving party of the service both use a non-charge line, the output of the information will be inhibited in order to preserve the integrity of the charging function. Moreover, if the line indicated by the identification data and the line on which the read request is received are both charge lines, a message is sent to the issuer of the read request to indicate the availability of a non-charge line. This prevents the sending party and the receiving party of the same service from being charged for the service.

A U.S. patent of Bufferd et al. U.S. Pat. No. 5,706,330 discloses a method and apparatus for tracking and transmitting communication information for wireless communication systems. As disclosed, a communication accounting system is provided wherein the transfer of call detail record information from a remotely located phone may be accomplished in an efficient manner. During non-billable processes or during airtime billed at a reduced rate, the call detail record (CDR) information from the previous registration is simultaneously sent to the collector system for processing to the billing system. More specifically, encrypted and compressed authorization information and call details records (CDRs) from the previous use of the phone are simultaneously communicated from the Cellular Call Computer—Programmable Off-line (C3PO) to the host computer system by modem or other suitable manner. At the validation server, the authorization information is decrypted and uncompressed and stripped away from the CDRs, while the call is live, and sent to an authorization service. While the validation system is working on completing the authorization, the system is uploading the CDRs from calls made since the last authorization attempt. These CDRs are stored for later processing. The invention also provides a roaming management system integrated with the accounting system. By the method, disclosed equipment is efficiently utilized, internal airtime charges are minimized, and customers are billed in a timely manner.

Further, a U.S. Pat. No. 7,406,307 of Manto discloses a system and method for providing interoperable and on-demand telecommunications service. The system relates in general to the field of voice and data communications, and in particular, to a novel system for providing interoperable on-demand communications and services across otherwise incompatible narrowband voice and broadband systems. The system is also based on sponsored or universal communications services supported by interactive communications between sponsors and service providers and their respective databases of business rules.

Finally, a U.S. Pat. No. 7,613,471 of Lee et al. discloses a method of providing SMS callback. The patent discloses a method of connecting two or more phone lines in a cross-country connection through a rented device. The device may be a mobile phone or a SIM card. A SMS message is sent from the rented device to a service provider bearing the identification of the phone lines to be connected. The SMS is received by a gateway of the service provider, and the gateway subsequently places calls to the phone lines in the SMS and connects the phone lines.

As indicated above in many cases it is more expensive to make telephone calls using a cell phone than making the same call over a conventional land line. This is particularly true with respect to long distance calls and even more particular to international calls. In some other cases some calls can be made without charge with a land based line, while calls using a cell phone may incur a charge. Therefore, it is believed that there is a need and a potential commercial market for a device that will allow a cell phone user to make calls over a land based line. It is also believed that such system would be relatively inexpensive to provide global and readily based on conventional pieces of telephone communication devices and systems. Accordingly, the contents of the aforementioned patents are incorporated herein in their entirety by reference.

### BRIEF SUMMARY OF THE INVENTION

In essence, the present invention contemplates a telephone system and/or device for making out of area or long distance telephone calls including international telephone calls from a cell phone at a reduced cost. Using the invention, a person with a cell phone places a telephone call using the cell phone to a pre-established number. The system upon receiving a call from a cell phone immediately records the telephone number of the cell phone from which the call is initiated and records that telephone number and immediately disconnects the call. The system and/or device recalls the cell phone number from a second or land line and delivers a message to the individual to redial the requested number. The call is then completed to the called number and the completed call is treated as an incoming call to the cell phone. The cell phone user is then charged for making a local call of short duration and in some cases for an incoming call. However, a company that provides the service will bill the cell phone user for the use of a land line for making the long distance call. In this way, the cell phone user will have reduced costs since they will pay only for the cost of a short duration local call plus the cost if any of receiving a call plus the use of the land line for the long distance call.

In the second embodiment of the invention the cell phone user calls an access code and is identified by a caller ID function and connected directly to a land line with a timer. The cell phone user inputs an out of area telephone number and after completion of the call is billed for the use of the land line. In this way the cell phone user is charged for a local call based on the duration of the call and in addition is charged for the use of a land line.

The invention will now be described in connection with the following drawings wherein like reference numerals have been used to identify like parts.

### DESCRIPTION OF THE DRAWINGS

FIG. 1 is a block diagram illustrating the overall configuration of a first preferred embodiment of the invention;

FIG. 2 is a block diagram illustrating the overall configuration of a second embodiment of the invention;

FIG. 3 is a block diagram illustrating the overall configuration of a method in accordance with the present invention; and

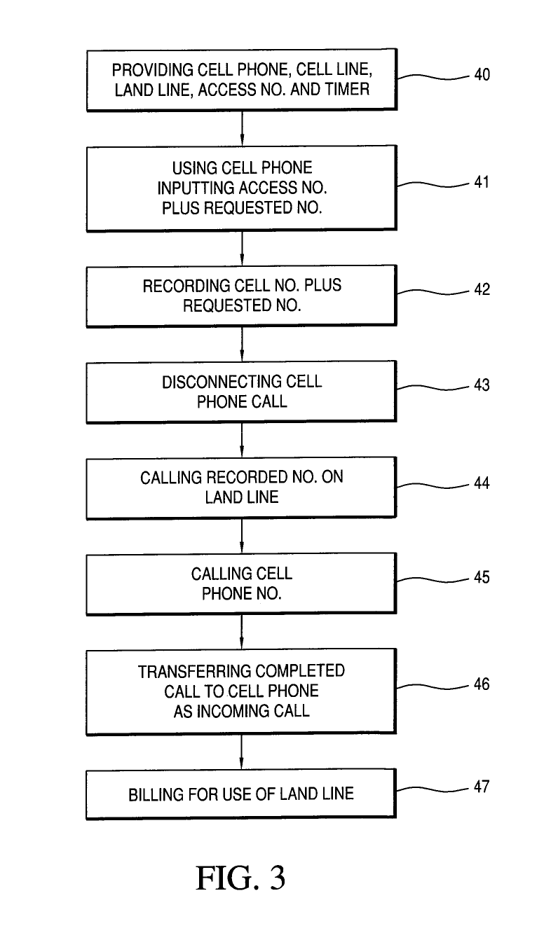

FIG. 4 is a schematic illustration of a display screen as used in the present invention.

### DESCRIPTION OF THE PREFERRED EMBODIMENTS OF THE INVENTION

A telephone system in accordance with a preferred embodiment of the invention is designed to receive a call from a cell phone, using caller ID or the like, recording the telephone number and immediately disconnecting the call from the cell phone. At this time the system redials the recorded cell phone number using a land line whereby the cell phone user will be billed or not billed according to the cell phone contracts as an incoming call. The cell phone user receives a recorded message from the system to redial the called number. At this stage the call to the out of area number is made using a land line and is treated as an incoming call from the system and thus billed at a considerably lower rate than if the out of area call was made on the cell phone. The system then bills the user of the cell phone for the charges associated with the use of the land line.

The telephone system includes a cell phone, and a cell phone line that is connected to a first “for charge” or cell line. The system also incorporates a land line connected to a second for charge line that charges a rate for line usage that is less than the charges for using the first line. In addition, the system provides an access code that the user dials to make a local call to gain entry into the system.

Upon gaining entry into the system, the telephone number of the cell phone is identified by caller ID and recorded by a recorder. The recorder also resends the requested telephone number entered from or by the cell phone after dialing the access code. At this stage, the system automatically terminates the call from the cell phone and places a call to the requested number on a land line.

Then, when the call made on the land line is completed, the system calls back to the cell phone and transfers the completed call to the cell phone as an incoming local call, records the time of the transferred call and bills the cell phone user for the use of the land line.

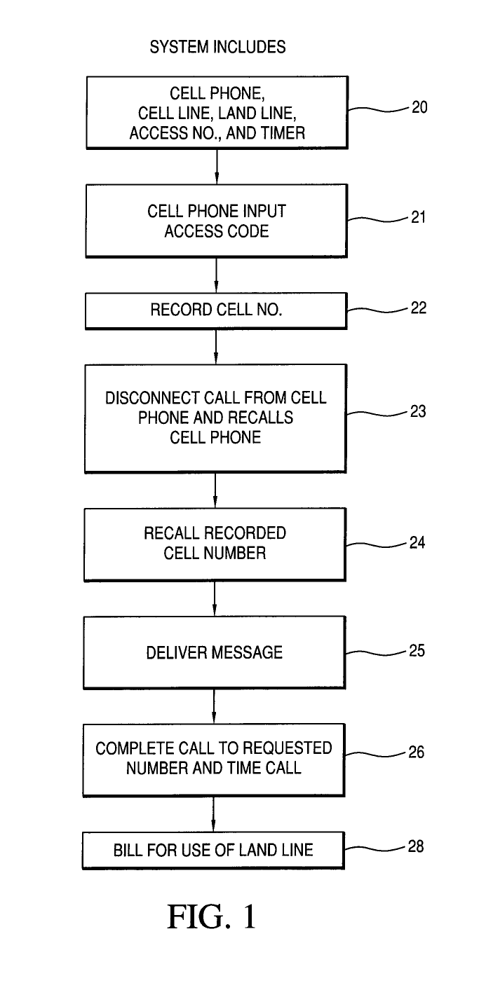

As illustrated in FIG. 1, a telephone communication system in accordance with the presently preferred embodiment of the invention comprises or consists of a cell phone, a cell phone line connected to a first for charge line, a second or land line connected to a second “for charge” line that charges less than the first charge line, an access code and a timer as indicated by the block 20 in FIG. 1. The cell phone is then used to dial the access code to gain access to the system as a local call.

The user of a cell phone dials an access code or phone number for a system or device in accordance with the present invention in step 21 and upon completion of the call, the system or device records the telephone number of the caller's cell phone in step 22. The system or device immediately disconnects the call from the cell phone in step 23 and recalls the recorded number of the cell phone in step 24 that is then reconnected to the cell phone as a received call.

The system or device delivers a prerecorded message to the cell phone user to redial the requested number in step 25. Then when the call is completed on a land line the timer is started in step 26 and when the call is ended, the system bills the cell phone user for the use of the land line in step 28.

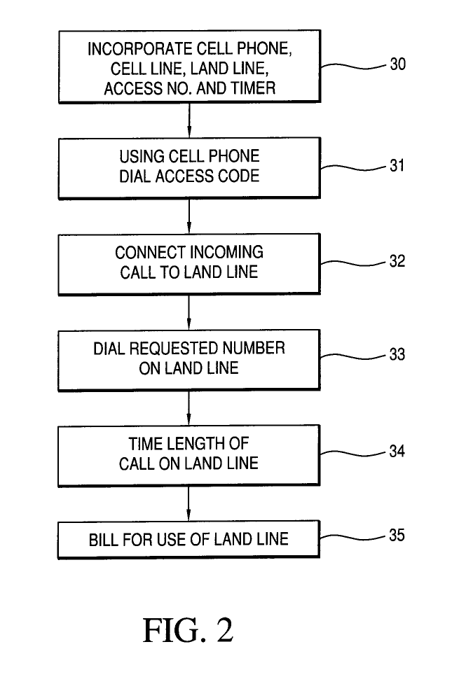

As illustrated in FIG. 2, a telephone system in accordance with a second embodiment of the invention incorporates a cell phone line, a land line an access number and a timer as indicated in step 30. To gain access and use the system a user inputs the access code into the cell phone and presses a send button in step 31. The system then automatically connects the cell phone to a land line in step 32 and the user of the cell phone inputs a requested out of area number in step 33. Then when a call is completed, the timer is started and times the use of the land line from acceptance of the call until its completion in block 34. Then the telephone communication system bills the user in step 35 for the use of the land line.

A telephone communication method according to a further embodiment of the invention includes the following steps:
providing a cell phone, cell phone line, land line, access code and timer in step 40 and using the cell phone to input the access code plus a requested out of area phone number in step 41;
in step 42 the cell phone number and requested number are recorded and the call from the cell phone is disconnected in step 43;
the system then places a call to the recorded out of area phone on the land line in step 44;
when the call to the out of area number is completed, the system calls the cell phone in step 45 and transfers the completed call to the cell phone as an incoming call in step 46;
the system bills the cell phone for the use of the land line in step 47.

In a preferred embodiment of the invention the system includes caller ID, an electronic clock including month, date and year and a signal when the land line and/or lines are busy.

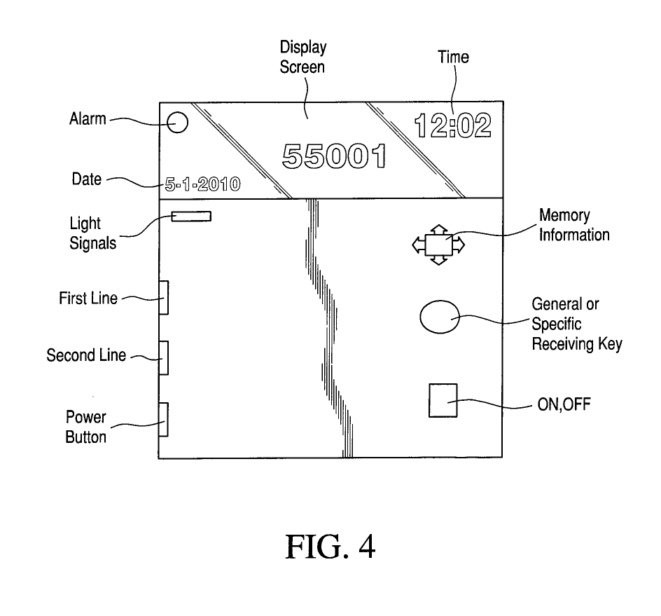

FIG. 4 illustrates a monitor or display as provided in one embodiment of the invention. As shown, the display shows the date and time in an upper portion of the display as well as a first and second line. A power button 50 as well as an on/off switch 52 is provided. Buttons for a first and second line are provided on one side of the display as well as a light indicating that they are in a receiving mode. Finally, a positioning key for memory and information may be provided as well as the light signal to indicate that the device is on or off. An alarm signal or light may be provided in an upper portion of the display screen to indicate that all available lines are busy.

While the invention has been described in connection with its accompanying drawings it should be recognized that changes and modifications may be made therein without departing from the scope of the appended claims.

What is claimed is:

1. A telephone system for making out of area calls from a cell phone at a reduced cost, said system comprising:
a cell phone, an access code, a cell phone line and a cell phone line connected to a first charge line and a second or land line connected to a second or charge line that charges less than the first charge line;
an access code and a timer;
means for registering a cell phone user and their cell phone number;
means for identifying a registered user by a registered cell phone number;
means for recording the cell phone number of an incoming call by a registered user;
means for immediately disconnecting the cell call upon recording the cell phone number;
recalling the recorded number of the cell phone;
delivering a prerecorded message or missed call notice to the cell phone to recall a requested out of area number;
when the call is completed over a land line the timer is stared; and
when the call is ended the system bills the cell phone user for the use of the land line.

2. A telephone system for receiving a telephone call from a cell phone, recording the telephone number of the cell phone, making a call to a requested telephone number on a land line and connecting a completed call to the cell phone as an incoming call, said system comprising:
a cell phone and a cell phone line connected to a first charge line;
a land line connected to a second charge line that charges less than said first charge line;
an access code for gaining access to said telephone system;
means for recording a number of said cell phone after inputting said access code;
means for connecting a call completed over said land line to said cell phone as a local call and charging a caller for the use of said land line.

3. A telephone system for receiving a telephone call from a cell phone, recording the telephone number of the cell phone, means for disconnecting the call from the cell phone and redialing the cell phone for connection thereto as a received call, making a call to a requested out of area telephone number on a land line and connecting a completed call to the cell phone as an incoming call according to claim 2 which includes means for disconnecting said call from said cell phone before placing a call over said land line.

4. A telephone system for receiving a telephone call from a cell phone, recording the telephone number of the cell phone, making a call to a requested telephone number on a land line and connecting a completed call to the cell phone as an incoming call according to claim 3 which includes means for sending a signal to said cell phone with said land line when said called number is busy.

5. A telephone system for receiving a telephone call from a cell phone, recording the telephone number of the cell phone, making a call to a requested out of area telephone number on a land line and connecting a completed call to the cell phone as an incoming call, said system consisting of:
a cell phone and a cell phone line connected to a first “for charge” line;
a land line connected to a second charge line which charges less than said first “for charge” line;
an access code for gaining access to said telephone system;
means for recording a number of said cell phone after inputting said access code;
means for disconnecting said call from said cell phone;
means for calling said recorded number over said land line;
means for recalling said cell phone and connecting said cell phone to a completed call as a local or received call; and
billing the user of the system for the use of said land line.

6. A telephone system for receiving a telephone call from a cell phone which is connected to a first charge line and connecting said cell phone to a land line that is connected to a second charge line that charges the said first charge line and completing a call to a number entered by said cell phone over said land line according to claim 4 in which said system includes caller ID.

7. A telephone system for receiving a telephone call from a cell phone which is connected to a first charge line and connecting said cell phone to a land line that is connected to a second charge line that charges less than the said first charge line and completing a call to a number entered on said cell phone over said land line according to claim 6 that includes an electronic clock with year, month, day and an alarm.

8. A telephone system for receiving a telephone call from a cell phone which is connected to a first charge line and connecting said cell phone to a land line that is connected to a second charge line that charges the said first charge line and completing a call to a number entered on said cell phone over said land line according to claim 7 which includes a signal that indicates that the land line is busy.

9. A telephone communication method comprising the steps of:
providing a cell phone having a cell phone number, a cell phone line, a land line, an access number and a timer;
using the cell phone to dial an access code and a requested number;
recording said phone number and the requested number;
disconnecting the call from the cell phone;
calling the requested number using the land line;
upon completion of the called number, call the cell phone;
transfer a completed call over the land line to the cell phone as an incoming call and time the duration of the call; and
bill the cell phone user for use of the land line.

10. A telephone communication method according to claim 9 in which said cell phone is connected to more than one land line.
